(19) United States
(12) Patent Application Publication
(10) Pub. No.: US 2021/0187837 A1
(43) Pub. Date: Jun. 24, 2021

(54) 3DP PRINTING METHOD AND SYSTEM, AND 3DP COMPREHENSIVE PRINTING METHOD

(71) Applicant: KOCEL INTELLIGENT MACHINERY LIMITED, Yinchuan, Ningxia (CN)

(72) Inventors: Fan PENG, Yinchuan, Ningxia (CN); Bao YANG, Yinchuan, Ningxia (CN); Zixiang ZHOU, Yinchuan, Ningxia (CN); Yinxue DU, Yinchuan, Ningxia (CN); Junwei WANG, Yinchuan, Ningxia (CN); Yi LIU, Yinchuan, Ningxia (CN)

(73) Assignee: KOCEL INTELLIGENT MACHINERY LIMITED, Yinchuan, Ningxia (CN)

(21) Appl. No.: 16/758,054

(22) PCT Filed: Oct. 30, 2018
(86) PCT No.: PCT/CN2018/112565

§ 371 Date: Apr. 22, 2020

(30) Foreign Application Priority Data
Oct. 30, 2017 (CN) 201711032220.2
Oct. 30, 2017 (CN) 201711035710.8

(51) Int. Cl. B29C 64/165; B33Y 10/00; B33Y 30/00; B33Y 50/02; B29C 64/209; B29C 64/393

(52) U.S. Cl. CPC B29C 64/165; B33Y 10/00; B29C 64/393; B33Y 50/02; B29C 64/209; B33Y 30/00

(57) ABSTRACT

The present invention relates to a 3DP dislocated printing method and system. During layer-by-layer powder laying printing, printing heads are circularly closed and opened along a plurality of spray holes in two sides of the width direction, so that the spray positions of printing areas on adjacent layers corresponding to a same spray hole are mutually staggered. When individual spray holes of the printing heads are blocked, the corresponding positions of the blocked spray holes in the adjacent layers are also mutually staggered, and the problem of interruption of sections of a printing module caused by the phenomenon of missing spray of binders due to the blockage of individual spray holes on a single layer does not occur, thereby improving the 3DP printing efficiency, and reducing maintenance costs of the printing heads. The present invention also relates to a 3DP comprehensive printing method. In the present invention, by means of dislocated printing of the printing heads and by performing printing by again planning a printing track after printing sizes on layers are divided, high-efficiency rapid printing can be achieved, and the defect of printing interruption of sections due to blockage of individual spray holes is avoided, thereby reducing maintenance costs of the printing heads and prolonging the service life of the printing heads.

The present application claims priority to Chinese Patent Application No. 201711032220.2, titled “3DP METHOD COMBINING STAGGERED-BY-LAYER PRINTING AND IN-LAYER PATTERN SEGMENTATION”, filed on Oct. 30, 2017 with the China National Intellectual Property Administration, and Chinese Patent Application No. 201711035710.8, titled “STAGGERED 3DP METHOD”, filed on the same day with the China National Intellectual Property Administration, both of which are incorporated herein by reference in their entirety.

### TECHNICAL FIELD

The present disclosure relates to the field of three-dimensional (3D) printing technologies, and in particular to a three-dimensional printing (3DP) method, a 3DP system, and a comprehensive 3DP method combining staggered printing and in-layer pattern segmentation.

### BACKGROUND

In binder jetting three dimensional printing (3DP) technology, a print head moves according to two-dimensional data of a cross section of a model and selectively jets binder at corresponding positions to finally form a layer under the control of a computer. After bonding of each layer, a molding cylinder is lowered by a distance equal to thickness of one layer, and a powder supply cylinder is raised by a certain height to push out more powder, where the powder is pushed into the molding cylinder, leveled and compacted by a power spreading roller. The above process is repeated until an entire object is bonded. In the above process, if some jet holes of the print head are blocked or damaged, blank blocks on which binder cannot be jetted will be generated in an entire printing process. Accumulation of the blank blocks in multiple layers will form a broken section in a printed model, thus the printed model cannot be fully formed. If this kind of problem occurs, it is required to shut down and repair the printer in time or replace the print head, increasing costs and prolonging production cycle.

### SUMMARY

In order to solve the problems of blanks and broken layers in printing caused by a few blocked jet holes of a print head in the conventional 3DP technology, a staggered 3DP method and a staggered 3DP system are provided according to the present disclosure, to stagger printing positions of each jet hole of the print head in layer-by-layer printing and thereby stagger positions of a blocked jet hole corresponding to two adjacent layers, avoiding broken sections in printing. A comprehensive 3DP method is further provided according to the present disclosure, to overcome the problems in conventional 3DP technology that broken sections may be caused by a few blocked jet holes of the print head and that printing efficiency may be affected due to the fact that the print head does not move quickly in blank areas of a pattern during printing.

In order to achieve the object of the present disclosure, a staggered 3DP method is provided. In the method, multiple jet holes at two sides of a print head along a width direction of the print head are closed and opened cyclically in a layer-by-layer powder spreading and printing process, so that jet positions of each jet hole on adjacent layers in a printing area are staggered with each other.

With the staggered printing method according to the present disclosure, multiple jet holes at two sides of the print head along the width direction of the print head are closed and opened cyclically, so that jet positions of the same jet hole on adjacent layers are staggered with each other. In a case that a few jet holes of the print head are blocked, jet positions of the few blocked jet holes in adjacent layers are staggered with each other. Missing of jet of binder on a single layer due to the few blocked jet holes will not cause the problem of broken sections within a printed model, and for a few scattered blocked jet holes, since corresponding jet positions are staggered with each other in printing of each layer, the problem of broken sections on the printed model will not arise either, thereby resolving the problem that the print head cannot continue printing due to the few blocked jet holes, improving the efficiency of 3DP and reducing maintenance cost of the print head.

In order to further achieve the object of the present disclosure, jet holes arranged along the width direction of the print head are divided into a front closed area, a rear closed area, and an open area between the front closed area and the rear closed area and for performing jet printing. In a layer-by-layer printing process, jet holes in the rear closed area are opened on a layer-by-layer basis, and jet holes in the front closed area are closed on a layer-by-layer basis, so that jet holes at a front end and a rear end of the open area are cyclically closed and opened in a staggered manner on a layer-by-layer basis to keep a width of the open area unchanged in printing of all layers. In the printing method according to the present disclosure, jet holes at the front end and the rear end of the open area of the print head are closed and opened alternately on a layer-by-layer basis, and the width of the open area is kept unchanged, so that jet positions of each jet hole of the print head in adjacent layers are always staggered with each other in the layer-by-layer printing process.

The staggered 3DP method according to the present disclosure may include:

step 1, setting a width of the front closed area along the width direction of the print head to zero, setting a width of the rear closed area to a maximum width, aligning the open area of the print head over a printing area of a printing platform, spreading a layer of powder on the printing platform by a powder spreading device, activating jet holes in the open area of the print head to perform selective jet printing on the printing area according to a slice printing program, and lowering a worktable by a height of a layer of powder after a current layer is printed;

step 2, opening a certain number of jet holes in the rear closed area that are close to the open area, closing jet holes at the front end of the open area that occupy a same width as the certain number of jet holes to form the front closed area with the width of the open area unchanged, moving the print head to a position where the open area is aligned over the printing area of the printing platform, activating, after spreading a layer of powder in the printing area, jet holes in the open area of the print head to perform selective jet printing on the printing area according to a slice printing program of a current layer, and lowering the worktable by the height of a layer of powder after the current layer is printed;
step 3, opening a certain number of jet holes in the rear closed area that are close to the open area again, closing jet holes in the print head that are close to the front closed area and occupy a same width as the certain number of jet holes, then moving the print head to align the open area over the printing area, activating, after spreading a layer of powder in the printing area, jet holes in the open area of the print head to perform selective jet printing on the printing area according to a slice printing program of a current layer, and lowering the worktable by the height of a layer of powder after the current layer is printed;

step 4, repeating step 3 iteratively until all jet holes in the rear closed area of the print head are opened and the width of the front closed area is the same as the width of the rear closed area in step 1, moving the print head to align the open area with the printing area, and lowering the worktable by the height of a layer of powder after power spreading and printing of a current layer are completed, where at this point a cycle of staggered use of all jet holes of the print head is completed; and step 5, restoring the print head to the state in step 1 to perform printing in a next cycle of staggered use of the jet holes, until 3DP of a product is completed.

The staggered 3DP method according to the present disclosure may include:

step 1, setting a width of the front closed area along the width direction of the print head to zero, setting a width of the rear closed area to a maximum width, aligning the open area of the print head over a printing area of a printing platform, spreading a layer of powder on the printing platform by a powder spreading device, activating jet holes in the open area of the print head to perform selective jet printing on the printing area according to a slice printing program, and lowering a worktable by a height of a layer of powder after a current layer is printed;

step 2, opening a certain number of jet holes in the rear closed area that are close to the open area, closing jet holes at the front end of the open area that occupy a same width as the certain number of jet holes to form the front closed area with the width of the open area unchanged, moving the print head to a position where the open area is aligned over the printing area of the printing platform, activating, after spreading a layer of powder in the printing area, jet holes in the open area of the print head to perform selective jet printing on the printing area according to a slice printing program of a current layer, and lowering the worktable by the height of a layer of powder after the current layer is printed;

step 3, opening a certain number of jet holes in the rear closed area that are close to the open area again, closing jet holes in the print head that are close to the front closed area and occupy a same width as the certain number of jet holes, then moving the print head to align the open area over the printing area, activating, after spreading a layer of powder in the printing area, jet holes in the open area of the print head to perform selective jet printing on the printing area according to a slice printing program of a current layer, and lowering the worktable by the height of a layer of powder after the current layer is printed;

step 4, repeating step 3 iteratively until all jet holes in the rear closed area of the print head are opened and the width of the front closed area is the same as the width of the rear closed area in step 1, moving the print head to align the open area with the printing area, and lowering the worktable by the height of a layer of powder after power spreading and printing of a current layer are completed, where at this point a cycle of forward staggered use of all jet holes of the print head is completed;

step 5, opening a certain number of jet holes in the front closed area of the print head that are close to the open area, where the width of the rear closed area along the width direction of the print head is zero and the width of the front closed area along the width direction of the print head is the maximum width after step 4 is performed, closing jet holes at the rear end of the open area that occupy a same width as the certain number of jet holes to form the rear closed area with the width of the open area unchanged, moving the print head to a position where the open area is aligned over the printing area of the printing platform, activating, after spreading a layer of powder in the printing area, jet holes in the open area of the print head to perform selective jet printing on the printing area according to a slice printing program of a current layer, and lowering the worktable by the height of a layer of powder after the current layer is printed;

step 6, opening a certain number of jet holes in the front closed area that are close to the open area again, closing jet holes in the print head that are close to the rear closed area and occupy a same width as the certain number of jet holes, then moving the print head to align the open area over the printing area, activating, after spreading a layer of powder in the printing area, jet holes in the open area of the print head to perform selective jet printing on the printing area according to a slice printing program of a current layer, and lowering the worktable by the height of a layer of powder after the current layer is printed;

step 7, repeating step 6 iteratively until all jet holes in the front closed area of the print head are opened and the width of the rear closed area is zero, moving the print head to align the open area with the printing area, and lowering the worktable by the height of a layer of powder after power spreading and printing of a current layer are completed, where at this point a cycle of reverse staggered use of all jet holes of the print head is completed; and step 8, repeating steps 1 to 7 to perform printing in a next cycle of staggered use of the jet holes, until 3DP of a product is completed.

With the above staggered 3DP method according to the present disclosure, a 3DP product is completed. In the layer-by-layer printing of the product, some jet holes of the print head are cyclically opened and closed, so that jet positions of each jet hole on different layers are staggered with each other, and blank areas on which binder cannot be jetted are effectively filled, improving the service life of the print head, reducing costs and improving printing efficiency.

Further, a sum of the widths of the front closed area and the rear closed area of the print head is 5% to 40% of a total width of the print head.

Further, the sum of the widths of the front closed area and the rear closed area of the print head is 7% to 10% of the total width of the print head.

Further, the widths of the front closed area and the rear closed area of the print head are changed in a staggered manner on a layer-by-layer basis, and the widths of the two closed areas increase or decrease between zero and the maximum width on a layer-by-layer basis.

A staggered 3DP system is provided. In the system, multiple jet holes are arranged at two sides of a print head along a width direction and are closed and opened cyclically, so that jet positions of each jet hole on adjacent layers in a printing area are staggered with each other in a layer-by-layer powder spreading and printing process.

Further, jet holes arranged along the width direction of the print head are divided into a front closed area, a rear closed area and an open area between the front closed area and the rear closed area and for performing jet printing. In a layer-by-layer printing process, jet holes in the rear closed area are opened on a layer-by-layer basis, and jet holes in the front closed area are closed on a layer-by-layer basis, so that jet holes at a front end and a rear end of the open area are cyclically closed and opened in a staggered manner on a layer-by-layer basis to keep a width of the open area unchanged in printing of all layers.

Further, a sum of widths of the front closed area and the rear closed area of the print head is 5% to 40% of a total width of the print head.

Further, the sum of the widths of the front closed area and the rear closed area of the print head is 7% to 10% of the total width of the print head.

Further, the widths of the front closed area and the rear closed area of the print head are changed in a staggered manner on a layer-by-layer basis, and the widths of the two closed areas increase or decrease between zero and a maximum width on a layer-by-layer basis.

A comprehensive 3DP method includes:

step 1, reading a data information file of a to-be-printed 3D model, loading printing information, and analyzing layering information of the 3D model to obtain a total layer number N;

step 2, checking a printing layer, including: loading a current printing layer, determining whether a serial number i of the current printing layer is less than the total layer number N, quitting, in a case that i is greater than N, that is, in case of false, a printing process to stop printing, and proceeding, in a case that i is less than or equal to N, that is, in case of true, to step 3 to execute a current printing process;

step 3, loading a staggering printing parameter of a print head, and determining, for the current layer, a printing width and numbers and positions of to-be-opened and to-be-closed jet holes of the print head;

step 4, dividing a printing pattern of the current layer into M closed patterns by the printing width of the print head, and determining a printing direction and a walking trajectory of the print head based on distribution information of the M closed patterns;

step 5, checking a current pattern, including:

loading a current printing pattern j of the current layer, determining whether the serial number j of the current printing pattern is less than the total number M of the closed patterns of the current layer, ending, in a case that j is greater than M, that is, in case of false, printing of the current layer and returning to step 2 to perform printing of an (i+1)^{th} layer, and proceeding, in a case that j is less than or equal to M, that is, in case of true, to step 6 to execute a printing program of the current pattern;

step 6, loading the printing program of the j^{th} pattern of the current layer, loading printing information based on a printing mode corresponding to the j^{th} pattern, and sending a printing command to a printing server to execute the printing of the current pattern; and

step 7, loading a (j+1)^{th} pattern of the current layer after the j^{th} pattern is printed, and returning to step 5.

In the method according the present disclosure, in printing of the layers, the print head operates in a staggered manner on a layer-by-layer basis, so that jet positions of a same jet hole on adjacent layers are staggered with each other, avoiding the defects of broken sections within a printed model caused by the failure to repair a few blocked or faulty jet holes in time. In printing of each layer, a whole pattern of each layer is divided into multiple patterns to be printed separately by a printing width, and a walking trajectory of the print head is re-designed to realize quick movement of the print head in blank areas of a printing pattern of each layer, thereby improving the printing efficiency. Therefore, by hierarchical staggered printing of the print head and performing printing after dividing the printing pattern of each layer and re-designing a printing trajectory according to the present disclosure, efficient and fast printing can be achieved, avoiding the defect of broken sections due to the few blocked jet holes in the print head, reducing maintenance costs of the print head and increasing the service life of the print head.

In order to further realize the staggered printing process performed by the print head according to the present disclosure, the staggering printing parameter of the print head in step 3 is determined as follows: jet positions of each jet hole on adjacent layers in a printing area are staggered with each other by cyclically closing and opening jet holes at two sides of the print head along a printing width direction in a layer-by-layer printing process starting from a layer with a serial number of 1.

In a further improvement of the staggered printing method according to the present disclosure, jet holes of the print head arranged along the printing width direction are divided into a front closed area, a rear closed area and an open area between the front closed area and the rear closed area and corresponding to the printing width. In a layer-by-layer printing process, jet holes in the rear closed area are opened on a layer-by-layer basis, and jet holes in the front closed area are closed on a layer-by-layer basis, so that jet holes at a front end and a rear end of the open area are cyclically closed and opened in a staggered manner on a layer-by-layer basis to keep a width of the open area unchanged in printing of all layers.

In order to facilitate the cyclic printing process according to the present disclosure, the current layer i in step 2 starts from a layer with a serial number of 1.

In order to facilitate the layer-by-layer printing process of all layers according to the present disclosure, the current pattern j in step 5 starts from a pattern with a serial number of 1.

Further, in the printing of the patterns of each layer, the walking trajectory of the print head in step 4 includes a walking trajectory of the print head over printing of each divided pattern and a walking trajectory of the print head from a printing end point of the current pattern to a printing start point of a next pattern.

### BRIEF DESCRIPTION OF THE DRAWINGS

FIG. 1 shows step 1 in a first embodiment or step 1 in a second embodiment of a staggered 3DP method according the present disclosure;

FIG. 2 shows step 2 in the first embodiment or steps 2 and 5 in the second embodiment of a staggered 3DP method according the present disclosure;

FIG. 3 shows step 3 in the first embodiment or steps 3 and 6 in the second embodiment of a staggered 3DP method according the present disclosure;

FIG. 4 shows step 4 in the first embodiment or steps 4 and 7 in the second embodiment of a staggered 3DP method according the present disclosure;

FIG. 5 is a flow chart of a comprehensive 3DP method according to the present disclosure;

FIG. 6 is a schematic diagram showing a staggered state of a print head and division of patterns in printing a layer using a comprehensive 3DP method according to the present disclosure; and

FIG. 7 is a schematic diagram showing a staggered state of a print head and division of patterns in printing another layer using a comprehensive 3DP method according to the present disclosure.

### DETAILED DESCRIPTION OF THE EMBODIMENTS

Hereinafter, the staggered 3DP method according to the present disclosure will be described in detail with reference to specific embodiments of a staggered 3DP system in conjunction with the drawings.

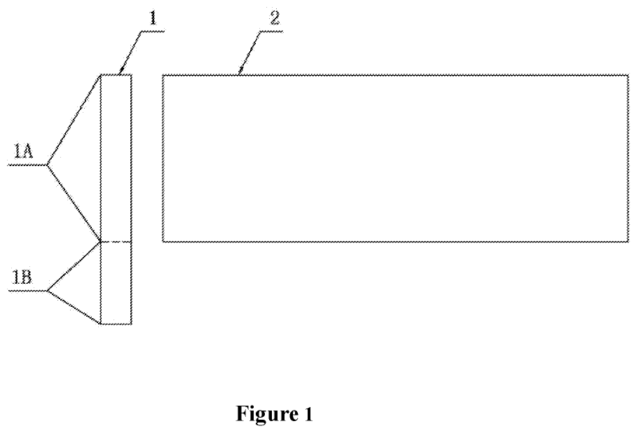

As shown in FIG. 1 to FIG. 4, in the staggered 3DP method according to the present disclosure, multiple jet holes at two sides of a print head 1 along a width direction of the print head are closed and opened cyclically in a layer-by-layer powder spreading and printing process, so that jet positions of each jet hole on adjacent layers in a printing area are staggered with each other.

In the staggered 3DP method according to the present disclosure, jet holes arranged along the width direction of the print head 1 are divided into a front closed area 1C, a rear closed area 1B, and an open area 1A between the front closed area and the rear closed area and for performing jet printing. In a layer-by-layer printing process, jet holes in the rear closed area 1B are opened on a layer-by-layer basis, and jet holes in the front closed area 1C are closed on a layer-by-layer basis, so that jet holes at a front end and a rear end of the open area 1A are cyclically closed and opened in a staggered manner on a layer-by-layer basis to keep a width of the open area 1A unchanged in printing of all layers. In the printing method according to the present disclosure, jet holes at the front end and the rear end of the open area 1A of the print head are closed and opened alternately on a layer-by-layer basis, and the width of the open area is kept unchanged, so that jet positions of each jet hole of the print head in adjacent layers are always staggered with each other in the layer-by-layer printing process.

According to a first embodiment of the present disclosure, the staggered 3DP method includes the following steps 1 to 5.

As shown in FIG. 1, there are 1024 jet holes in the print head along an entire width of the print head according to the embodiment. In step 1, in performing jet printing of each layer, 78 jet holes of the 1024 jet holes are closed, a width of the front closed area arranged along a width direction of the print head 1 is set to zero, a width of the rear closed area 1B along the width direction of the print head 1 is set to a maximum width, that is, a closed area is entirely located at a rear end of the print head 1, that is, 78 jet holes at the rear end of the print head are closed, the open area 1A of the print head is aligned over a printing area 2 on a printing platform, a layer of powder is spread on the printing platform by a powder spreading device, jet holes in the open area 1A of the print head are activated to perform selective jet printing on the printing area 2 according to a slice printing program, and a worktable is lowered by a height of a layer of powder after a current layer is printed.

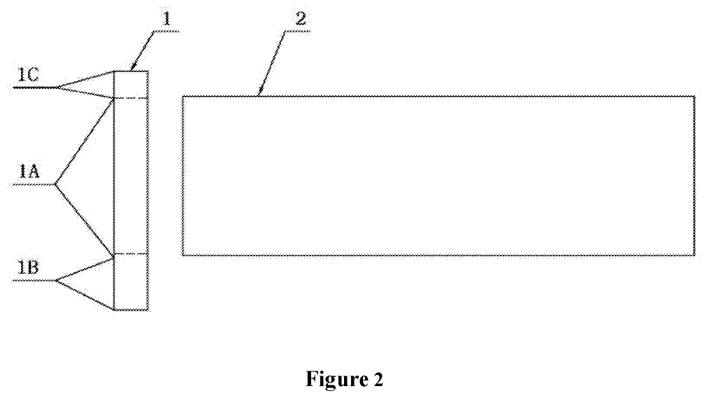

In step 2, as shown in FIG. 2, 26 jet holes in the rear closed area 1B that are close to the open area 1A are opened, 26 jet holes at a front end of the open area 1A are closed to form the front closed area 1C with the width of the open area 1A unchanged, the print head is moved to a position where the open area 1A of the print head is aligned over the printing area 2 of the printing platform, jet holes in the open area 1A of the print head are activated to perform selective jet printing on the printing area according to a slice printing program of a current layer after a layer of powder is spread in the printing area 2, and the worktable is lowered by the height of a layer of powder after the current layer is printed.

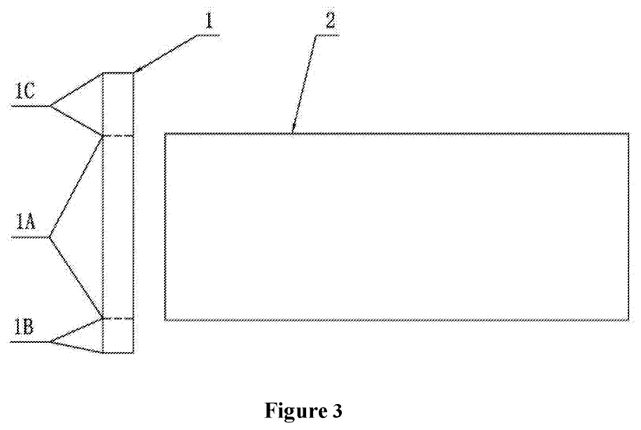

In step 3, as shown in FIG. 3, 26 jet holes in the rear closed area 1B that are close to the open area are opened again, 26 jet holes in the print head that are close to the front closed area 1C are closed, then the print head 1 is moved to align the open area 1A over the printing area 2, jet holes in the open area of the print head are activated to perform selective jet printing on the printing area according to a slice printing program of a current layer after a layer of powder is spread in the printing area, and the worktable is lowered by the height of a layer of powder after the current layer is printed.

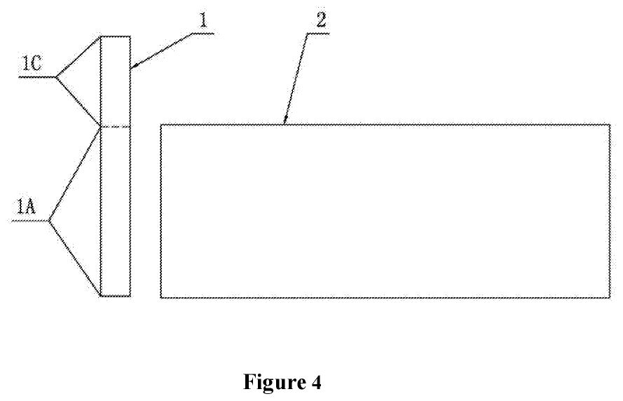

In step 4, as shown in FIG. 4, 26 remaining jet holes in the rear closed area are opened, 26 jet holes in the open area 1A that are close the front closed area are closed, where at this point all jet holes in the rear closed area are opened and 78 jet holes in the front close are all opened, the print head is moved to align the open area 1A with the printing area 2, and the worktable is lowered by the height of a layer of powder after power spreading and printing of a current layer are completed. At this point, a cycle of staggered use of all jet holes of the print head is completed. In the cycle of staggered use of all jet holes of the print head, jet positions of each jet hole on adjacent layers are staggered with each by 26 jet holes along the width direction.

In step 5, the closed areas and the open area of the print head are restored to the state in step 1 to perform printing in a next cycle of staggered use of the jet holes, until 3DP of a product is completed.

After steps 1 to 4 are performed, step 5 may alternatively include: performing step 3, step 2, and step 1 in sequence by the print head from a current state, and lowering the worktable by the height of a layer of powder after the current layer is printed; repeating step 1 iteratively until all jet holes in the front closed area of the print head are opened and the width of the rear closed area is the same as the width of the front closed area in step 1; moving the print head to a position where the open area is aligned with the printing area, and lowering the worktable by the height of a layer of powder after powder spreading and print of a current layer is completed. At this point, a cycle of staggered use of all the jet holes of the print head is completed, and printing in a next cycle of staggered use of the jet holes is started from the state in step 1 until the 3DP of the product is completed.

According to a second embodiment of the present disclosure, the staggered 3DP method includes the following steps 1 to 8.

As shown in FIG. 1, there are 1024 jet holes in the print head along an entire width of the print head according to the embodiment. In step 1, in performing jet printing of each layer, 78 jet holes of the 1024 jet holes are closed, a width of the front closed area arranged along a width direction of the print head 1 is set to zero, a width of the rear closed area 1B along the width direction of the print head 1 is set to a maximum width, the open area 1A of the print head is aligned over a printing area 2 on a printing platform, a layer of powder is spread on the printing platform by a powder spreading device, all jet holes in the open area 1A of the print head are activated to perform selective jet printing on the printing area 2 according to a slice printing program, and a worktable is lowered by a height of a layer of powder after a current layer is printed.

In step 2, as shown in FIG. 2, 26 jet holes in the rear closed area 1B that are close to the open area 1A are opened, 26 jet holes at a front end of the open area 1A along the width direction are closed to form the front closed area 1C with the width of the open area 1A unchanged, the print head is moved to a position where the open area 1A of the print head is aligned over the printing area 2 of the printing platform, all jet holes in the open area 1A of the print head are activated to perform selective jet printing on the printing area 2 according to a slice printing program of a current layer after a layer of powder is spread in the printing area 2, and the worktable is lowered by the height of a layer of powder after the current layer is printed.

In step 3, as shown in FIG. 3, 26 jet holes in the rear closed area 1B that are close to the open area 1A are opened again, 26 jet holes in the print head that are close to the front closed area 1C and occupy a same width are closed, then the print head 1 is moved to align the open area 1A over the printing area 2, all jet holes in the open area of the print head are activated to perform selective jet printing on the printing area 2 according to a slice printing program of a current layer after a layer of powder is spread in the printing area, and the worktable is lowered by the height of a layer of powder after the current layer is printed.

In step 4, step 3 is repeated iteratively until all jet holes in the rear closed area 1B of the print head are opened and a width of the front closed area 1C is the same as the width of the rear closed area 1B in step 1, the print head is moved to align the open area 1A with the printing area 2, and the worktable is lowered by the height of a layer of powder after power spreading and printing of a current layer are completed, where at this point a cycle of forward staggered use of all jet holes of the print head is completed.

As shown in FIG. 3, after step 4 is performed, the width of the rear closed area 1B of the print head along the width direction is zero, and the width of the front closed area 1C along the width direction is the maximum width. In step 5, 26 jet holes in the front closed area 1C of the print head that are close to the open area 1A are opened, jet holes at the rear end of the open area 1A that occupy a same width are closed to form the rear closed area 1B with the width of the open area unchanged, the print head is moved to a position where the open area 1A of the print head is aligned over the printing area 2 of the printing platform, all jet holes in the open area 1A of the print head are activated, after a layer of powder is spread in the printing area 2, to perform selective jet printing on the printing area 2 according to a slice printing program of a current layer after a layer of powder is spread in the printing area 2, and the worktable is lowered by the height of a layer of powder after the current layer is printed.

In step 6, as shown in FIG. 2, 26 jet holes in the front closed area 1C that are close to the open area 1A are opened again, jet holes of the print head that are close to the rear closed area 1B and occupy a same width, then the print head is moved to align the open area 1A over the printing area 2, all jet holes in the open area 1A of the print head are activated to perform selective jet printing on the printing area 2 according to a slice printing program of a current layer after a layer of powder is spread in the printing area 2, and the worktable is lowered by the height of a layer of powder after the current layer is printed.

In step 7, as shown in FIG. 1, step 6 is repeated iteratively until the jet holes in the front closed area 1C of the print head are all opened and the width of the rear closed area 1B is equal to zero, the print head is moved to align the open area 1A with the printing area 2, and the worktable is lowered by the height of a layer of powder after power spreading and printing of a current layer are completed, where at this point a cycle of reverse staggered use of all jet holes of the print head is completed.

In step 8, steps 1 to 7 are repeated to perform printing in a next cycle of staggered use of the jet holes, until 3DP of a product is completed.

With the above staggered 3DP method according to the present disclosure, a 3DP product is completed. In the layer-by-layer printing of the product, some jet holes of the print head are cyclically opened and closed, so that jet positions of each jet hole on different layers are staggered with each other, and blank areas on which binder cannot be jetted are effectively filled, improving the service life of the print head, reducing costs and improving printing efficiency.

A staggered 3DP system is provided according to an embodiment. In the system, multiple jet holes are arranged at two sides of a print head 1 along a width direction and are closed and opened cyclically, so that jet positions of each jet hole on adjacent layers in a printing area 2 are staggered with each other in a layer-by-layer powder spreading and printing process.

Jet holes arranged along a width direction of the print head 1 are divided into a front closed area 1C, a rear closed area 1B, and an open area 1A between the front closed area and the rear closed area and for performing jet printing. In a layer-by-layer printing process, jet holes in the rear closed area 1B are opened on a layer-by-layer basis, and jet holes in the front closed area 1C are closed on a layer-by-layer basis, so that jet holes at a front end and a rear end of the open area 1 are cyclically closed and opened in a staggered manner on a layer-by-layer basis to keep a width of the open area unchanged in printing of all layers.

A sum of widths of the front closed area 1C and the rear closed area 1B of the print head 1 is 5% to 40%, more preferably, 7% to 10%, of a total width of the print head. The widths of the front closed area 1C and the rear closed area 1B of the print head 1 are changed in a staggered manner on a layer-by-layer basis, and the widths of the two closed areas increase or decrease between zero and a maximum width on a layer-by-layer basis.

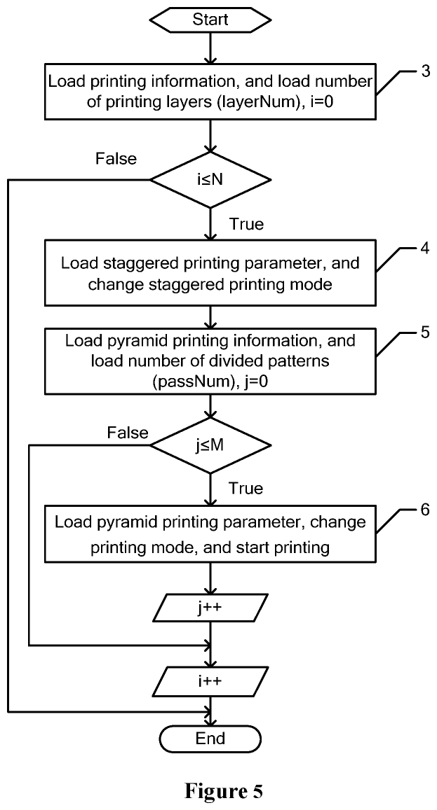

Hereinafter, a comprehensive 3DP method according to a specific embodiment of the present disclosure will be described in detail in conjunction with the FIG. 5 to FIG. 7, which combines staggered-by-layer printing and in-layer pattern segmentation.

According to the embodiment, the comprehensive 3DP method combining staggered-by-layer printing and in-layer pattern segmentation is performed according to the printing process shown in FIG. 5.

In step 1, a data information file of a to-be-printed 3D model is read, printing information is loaded, and layering information of the 3D model is analyzed to obtain a total layer number N.

In step 2, a printing layer is checked. A current printing layer is loaded starting from layer 1. It is determined whether a serial number i of the current printing layer is less than the total layer number N. If i is greater than N, that is, in case of false, the printing process is quitted, and printing is ended. If i is less than or equal to N, that is, in case of true, step 3 is performed to execute the printing.

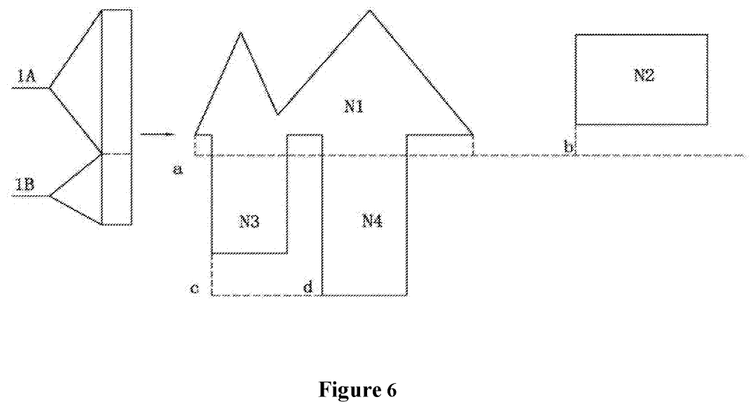

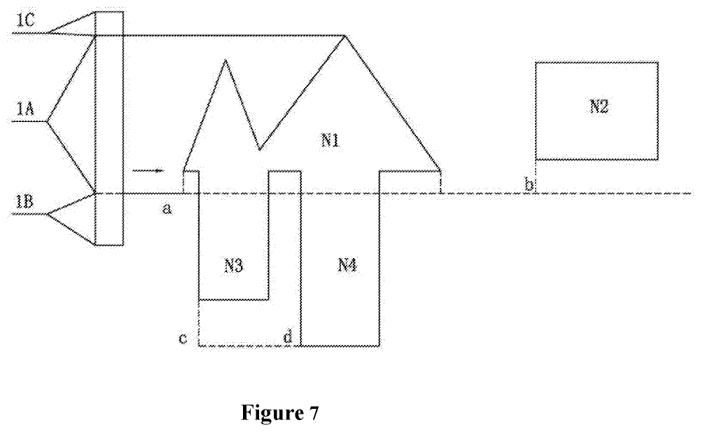

In step 3, a staggering printing parameter of a print head is loaded, and a printing width of the print head and numbers and positions of to-be-opened and to-be-closed jet holes of the print head are determined for printing a current layer. As shown in FIG. 6, the staggering printing parameter of the print head is determined as follows: jet positions of each jet hole on adjacent layers in a printing area are staggered with each other by cyclically closing and opening a certain number of jet holes at two sides of a printing width of the print head along the printing width, that is, along a width direction corresponding the open area 1A in FIG. 6, in a layer-by-layer printing process starting from a layer with a serial number of 1. As shown in FIG. 6, the jet holes in the open area 1A of the print head are opened, and jet holes in a closed area 1B at one side of the print head are closed. In printing of the current layer, only the jet holes in the open area 1A are activated to perform selective jet printing according to a printing pattern. When performing printing of a next layer after the current layer is printed, as shown in FIG. 7, the open area 1A of the print head is staggered by a certain width along the printing width direction, and a printing area 1A, a closed area 1B, and a closed area 1C are formed after the print head is staggered. Printing of the current layer is performed after the print head is staggered for the current layer. When performing printing of a next layer, the print head is further staggered to form a new open area and new closed areas, which is repeated cyclically on a layer-by-layer basis. The above process of staggering of the print head is repeated cyclically in printing of the entire model. By staggering jet holes of the print head, jet positions of each jet hole on patterns of adjacent layers are staggered with each other. Even if a few jet holes are blocked or fail, sparse missing of jetting of binder on a single layer will not affect the bonding quality of the overall layers, and the entire printed model will not have the defect of broken sections due to missing of jetting of binder on a same longitudinal position.

In step 4, a printing pattern of the current layer is divided into M closed patterns by the printing width of the print head, and a printing direction and a walking trajectory of the print head are determined based on distribution information of the M closed patterns. FIG. 6 shows a printing pattern of the current layer. The whole current printing pattern is divided into four patterns N1, N2, N3, and N4 along dotted lines in the printing pattern by the printing width of the print head. When printing the four patterns in sequence, starting points of the print head corresponding to the four patterns are a, b, c, and d. That is, the walking trajectory of the print head is as follow. Pattern N1 is printed from point a, the print head is quickly moved from an end point of the pattern N1 to point b to printing pattern N2 after pattern N1 is printed, then the print head is quickly moved from an end point of pattern N2 to pattern N3 to printing pattern N3 after pattern N2 is printed, and finally the print head is quickly moved from an end point of pattern N3 to point d to printing pattern N4 after pattern N3 is printed.

In step 5, pattern information of the current printing layer is loaded. When printing patterns of the current layer, it is required to check a current pattern to determine whether printing of the current layer has been finished or is to be continued. In this step, starting from a first pattern of the current layer, a current printing pattern j of the current layer is loaded, and it is determined whether the serial number j of the current printing pattern is less than the total number M of the closed patterns of the current layer. If j is greater than M, that is, in case of false, printing of the current layer is ended and step 2 is performed to print an (i+1)^{th} layer. If j is less than or equal to M, that is, in case of true, step 6 is performed to execute a printing program of the current pattern.

In step 6, a printing program of the current printing pattern j of the current layer is loaded, printing information is loaded based on a printing mode corresponding to the j^{th} pattern, and a printing command is sent to a printing server to execute the printing of the current pattern.

In step 7, a (j+1)^{th} pattern of the current layer is loaded after the j^{th} pattern is printed, after which step 5 is performed.

In the method according the present disclosure, in printing of the layers, the print head operates in a staggered manner on a layer-by-layer basis, so that jet positions of a same jet hole on adjacent layers are staggered with each other, avoiding the defects of broken sections within a printed model caused by the failure to repair a few blocked or faulty jet holes in time. In printing of each layer, a whole pattern of each layer is divided into multiple patterns to be printed separately by a printing width, and a walking trajectory of the print head is re-designed to realize quick movement of the print head in blank areas of a printing pattern of each layer, thereby improving the printing efficiency. Therefore, by hierarchical staggered printing of the print head and performing printing after dividing the printing pattern of each layer and re-designing a printing trajectory according to the present disclosure, efficient and fast printing can be achieved, avoiding the defect of broken sections due to the few blocked jet holes in the print head, reducing maintenance costs of the print head and increasing the service life of the print head.

The present disclosure is not limited to the above embodiments. In printing of the layers, appropriate changes may be made on how to cyclically stagger opening and closing of the print head and how to divide a pattern of each layer according to printing requirements. Based on the technical solution of the present disclosure, those skilled in the art can make some equivalents and modifications to some of the technical features without any creative efforts, and these equivalents and modifications shall fall within the scope of the present disclosure.

1. A staggered three-dimensional printing (3DP) method, wherein
a plurality of jet holes at two sides of a print head along a width direction of the print head are closed and opened cyclically in a layer-by-layer powder spreading and printing process, whereby jet positions of each jet hole on adjacent layers in a printing area are staggered with each other.

2. The staggered 3DP method according to claim 1, wherein:
jet holes arranged along the width direction of the print head are divided into a front closed area, a rear closed area, and an open area between the front closed area and the rear closed area and for performing jet printing; and in a layer-by-layer printing process, jet holes in the rear closed area are opened on a layer-by-layer basis, and jet holes in the front closed area are closed on a layer-by-layer basis, whereby jet holes at a front end and a rear end of the open area are cyclically closed and opened in a staggered manner on a layer-by-layer basis to keep a width of the open area unchanged in printing of all layers.

3. The staggered 3DP method according to claim 1, comprising:
step 1, setting a width of a front closed area along the width direction of the print head to zero, setting a width of a rear closed area to a maximum width, aligning an open area of the print head over a printing area of a printing platform, spreading a layer of powder on the printing platform by a powder spreading device, activating jet holes in the open area of the print head to perform selective jet printing on the printing area according to a slice printing program, and lowering a worktable by a height of a layer of powder after a current layer is printed;
step 2, opening a certain number of jet holes in the rear closed area that are close to the open area, closing jet holes at a front end of the open area that occupy a same width as the certain number of jet holes to form the front closed area with a width of the open area unchanged, moving the print head to a position where the open area is aligned over the printing area of the printing platform, activating, after spreading a layer of powder in the printing area, the jet holes in the open area of the print head to perform selective jet printing on the printing area according to a slice printing program of a current layer, and lowering the worktable by the height of a layer of powder after the current layer is printed;
step 3, opening a certain number of jet holes in the rear closed area that are close to the open area again, closing jet holes in the print head that are close to the front closed area and occupy a same width as the certain number of jet holes, moving the print head to align the open area over the printing area, activating, after spreading a layer of powder in the printing area, jet holes in the open area of the print head to perform selective jet printing on the printing area according to a slice printing program of a current layer, and lowering the worktable by the height of a layer of powder after the current layer is printed;
step 4, repeating step 3 iteratively until all jet holes in the rear closed area of the print head are opened and the width of the front closed area is the same as the width of the rear closed area in step 1, moving the print head to align the open area with the printing area, and lowering the worktable by the height of a layer of powder after power spreading and printing of a current layer are completed, wherein at this point a cycle of staggered use of all jet holes of the print head is completed; and
step 5, restoring the print head to the state in step 1 to perform printing in a next cycle of staggered use of the jet holes, until 3DP of a product is completed.

4. The staggered 3DP method according to claim 1, comprising:
step 1, setting a width of a front closed area along the width direction of the print head to zero, setting a width of a rear closed area to a maximum width, aligning an open area of the print head over a printing area of a printing platform, spreading a layer of powder on the printing platform by a powder spreading device, activating jet holes in the open area of the print head to perform selective jet printing on the printing area according to a slice printing program, and lowering a worktable by a height of a layer of powder after a current layer is printed;
step 2, opening a certain number of jet holes in the rear closed area that are close to the open area, closing jet holes at a front end of the open area that occupy a same width as the certain number of jet holes to form the front closed area with a width of the open area unchanged, moving the print head to a position where the open area is aligned over the printing area of the printing platform, activating, after spreading a layer of powder in the printing area, jet holes in the open area of the print head to perform selective jet printing on the printing area according to a slice printing program of a current layer, and lowering the worktable by the height of a layer of powder after the current layer is printed;
step 3, opening a certain number of jet holes in the rear closed area that are close to the open area again, closing jet holes in the print head that are close to the front closed area and occupy a same width as the certain number of jet holes, moving the print head to align the open area over the printing area, activating, after spreading a layer of powder in the printing area, jet holes in the open area of the print head to perform selective jet printing on the printing area according to a slice printing program of a current layer, and lowering the worktable by the height of a layer of powder after the current layer is printed;
step 4, repeating step 3 iteratively until all jet holes in the rear closed area of the print head are opened and the width of the front closed area is the same as the width of the rear closed area in step 1, moving the print head to align the open area with the printing area, and lowering the worktable by the height of a layer of powder after power spreading and printing of a current layer are completed, wherein at this point a cycle of forward staggered use of all jet holes of the print head is completed;
step 5, opening a certain number of jet holes in the front closed area of the print head that are close to the open area, wherein the width of the rear closed area along the width direction of the print head is zero and the width of the front closed area along the width direction of the print head is the maximum width after step 4 is performed, closing jet holes at a rear end of the open area that occupy a same width as the certain number of jet holes to form the rear closed area with the width of the open area unchanged, moving the print head to a position where the open area is aligned over the printing area of the printing platform, activating, after spreading a layer of powder in the printing area, jet holes in the open area of the print head to perform selective jet printing on the printing area according to a slice printing program of a current layer, and lowering the worktable by the height of a layer of powder after the current layer is printed;
step 6, opening a certain number of jet holes in the front closed area that are close to the open area again, closing jet holes in the print head that are close to the rear closed area and occupy a same width as the certain number of jet holes, moving the print head to align the open area over the printing area, activating, after spreading a layer of powder in the printing area, jet holes in the open area of the print head to perform selective jet printing on the printing area according to a slice printing program of a current layer, and lowering the worktable by the height of a layer of powder after the current layer is printed;
step 7, repeating step 6 iteratively until all jet holes in the front closed area of the print head are opened and the width of the rear closed area is zero, moving the print head to align the open area with the printing area, and lowering the worktable by the height of a layer of powder after power spreading and printing of a current layer are completed, wherein at this point a cycle of reverse staggered use of all jet holes of the print head is completed; and
step 8, repeating steps 1 to 7 to perform printing in a next cycle of staggered use of the jet holes, until 3DP of a product is completed.

5. The staggered 3DP method according to claim 1, wherein a sum of widths of a front closed area and a rear closed area of the print head is 5% to 40% of a total width of the print head.

6. The staggered 3DP method according to claim 5, wherein the sum of the widths of the front closed area the rear closed area of the print head is 7% to 10% of the total width of the print head.

7. The staggered 3DP method according to claim 1, wherein widths of a front closed area and a rear closed area of the print head are changed in a staggered manner on a layer-by-layer basis, and the widths of the two closed areas increase or decrease between zero and a maximum width on a layer-by-layer basis.

8. A staggered 3DP system, wherein
a plurality of jet holes are arranged at two sides of a print head along a width direction and are closed and opened cyclically, whereby jet positions of each jet hole on adjacent layers in a printing area are staggered with each other in a layer-by-layer powder spreading and printing process.

9. The staggered 3DP system according to claim 8, wherein:
jet holes arranged along the width direction of the print head are divided into a front closed area, a rear closed area and an open area between the front closed area and the rear closed area and for performing jet printing; and in a layer-by-layer printing process, jet holes in the rear closed area are opened on a layer-by-layer basis, and jet holes in the front closed area are closed on a layer-by-layer basis, whereby jet holes at a front end and a rear end of the open area are cyclically closed and opened in a staggered manner on a layer-by-layer basis to keep a width of the open area unchanged in printing of all layers.

10. The staggered 3DP system according to claim 8, wherein a sum of widths of a front closed area and a rear closed area of the print head is 5% to 40% of a total width of the print head.

11. The staggered 3DP system according to claim 10, wherein the sum of the widths of the front closed area and the rear closed area of the print head is 7% to 10% of the total width of the print head.

12. The staggered 3DP system according to claim 8, wherein widths of a front closed area and a rear closed area of the print head are changed in a staggered manner on a layer-by-layer basis, and the widths of the two closed areas increase or decrease between zero and a maximum width on a layer-by-layer basis.

13. A comprehensive 3DP method, comprising the staggered 3DP method according to claim 1, and comprising:
step 1, reading a data information file of a to-be-printed 3D model, loading current printing information, and analyzing layering information of the 3D model to obtain a total layer number N;
step 2, checking a printing layer, comprising: loading a current printing layer, determining whether a serial number i of the current printing layer is less than the total layer number N, quitting, in a case that i is greater than N, that is, in case of false, a printing process to stop printing, and proceeding, in a case that i is less than or equal to N, that is, in case of true, to step 3 to execute a current printing process;
step 3, staggering jet positions of each jet hole on adjacent layers in a printing area with each other by cyclically closing and opening a certain number of jet holes at two sides of a printing width of the print head along the printing width in a layer-by-layer printing process starting from a layer with a serial number of 1;
step 4, dividing a printing pattern of the current layer into M closed patterns by the printing width of the print head, and determining a printing direction and a walking trajectory of the print head based on distribution information of the M closed patterns;
step 5, checking a current pattern, comprising:
loading a current printing pattern j of the current layer, determining whether the serial number j of the current printing pattern is less than the total number M of the closed patterns of the current layer, ending, in a case that j is greater than M, that is, in case of false, printing of the current layer and returning to step 2 to perform printing of an (i+1)^{th} layer, and proceeding, in a case that j is less than or equal to M, that is, in case of true, to step 6 to execute a printing program of the current pattern;
step 6, loading the printing program of the j^{th} pattern of the current layer, loading printing information based on a printing mode corresponding to the j^{th} pattern, and sending a printing command to a printing server to execute the printing of the current pattern; and
step 7, loading a (j+1)^{th} pattern of the current layer after the j^{th} pattern is printed, and returning to step 5.

14. The comprehensive 3DP method according to claim 13, wherein:
jet holes of the print head arranged along a printing width direction are divided into a front closed area, a rear closed area and an open area between the front closed area and the rear closed area and corresponding to a printing width; and in a layer-by-layer printing process, jet holes in the rear closed area are opened on a layer-by-layer basis, and jet holes in the front closed area are closed on a layer-by-layer basis, whereby jet holes at a front end and a rear end of the open area are cyclically closed and opened in a staggered manner on a layer-by-layer basis to keep a width of the open area unchanged in printing of all layers.

15. The comprehensive 3DP method according to claim 13, wherein the current layer i in step 2 starts from a layer with a serial number of 1.

16. The comprehensive 3DP method according to claim 13, wherein the current pattern j in step 5 starts from a pattern with a serial number of 1.

17. The comprehensive 3DP method according to claim 13, wherein
the walking trajectory of the print head in step 4 comprises a walking trajectory of the print head over printing of each divided pattern and a walking trajectory of the print head from a printing end point of the current pattern to a printing start point of a next pattern.
